(19) United States
(12) Patent Application Publication
(10) Pub. No.: US 2022/0043920 A1
(43) Pub. Date: Feb. 10, 2022

(54) BLOCKCHAIN-BASED SECURE FEDERATED LEARNING

(71) Applicant: FUJITSU LIMITED, Kawasaki-shi (JP)

(72) Inventors: Qiong ZHANG, Plano, TX (US); Paparao PALACHARLA, Richardson, TX (US); Junichi SUGA, Otaku (JP); Toru KATAGIRI, Kawasaki (JP); Tadashi IKEUCHI, Plano, TX (US); Motoyoshi SEKIYA, Chigasaki (JP)

(73) Assignee: FUJITSU LIMITED, Kawasaki-shi (JP)

(21) Appl. No.: 17/357,806

(22) Filed: Jun. 24, 2021

Related U.S. Application Data
(60) Provisional application No. 63/071,072, filed on Aug. 27, 2020.
(60) Provisional application No. 62/706,227, filed on Aug. 6, 2020.

(51) Int. Cl. G06F 21/60; H04L 9/30; G06N 20/00

(52) U.S. Cl. CPC G06F 21/604; H04L 9/30; H04L 2209/04; H04L 2209/38; G06N 20/00

(57) ABSTRACT

A method may include publishing metadata to a blockchain, the metadata describing a training task associated with a global machine-learning model and computational resource requirements for performing the training task. The method may include receiving a request to participate in training the global machine-learning model from one or more clients based on a relevance of a respective local dataset of each of the clients to the training task and a suitability of the clients to the computational resource requirements for performing the training task. The method may include obtaining local model updates in which each respective local model corresponds to a respective client and each respective local model update is generated based on training the global machine-learning model with each of the local datasets. The method may include aggregating the plurality of local model updates and generating an updated global machine-learning model based on the aggregated local model update.

The present disclosure generally relates to blockchain-based secure federated learning.

### BACKGROUND

A machine-learning model may be trained based on training data. The machine-learning model may be trained according to a distributed machine-learning approach in which the machine-learning model may be trained on decentralized datasets. Training the machine-learning model according to such a distributed machine-learning approach may be called federated learning.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a method may include publishing metadata to a blockchain, the metadata describing a training task associated with a global machine-learning model and computational resource requirements for performing the training task. The method may include receiving a request to participate in training the global machine-learning model from one or more clients based on a relevance of a respective local dataset of each of the clients to the training task and a suitability of the clients to the computational resource requirements for performing the training task. The method may include obtaining local model updates in which each respective local model corresponds to a respective client and each respective local model update is generated based on training the global machine-learning model with each of the local datasets. The method may include aggregating the plurality of local model updates and generating an updated global machine-learning model based on the aggregated local model update.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1 is a diagram representing an example system for federated learning and training of a global machine-learning model facilitated by a metadata blockchain according to the present disclosure;

FIG. 2 is a diagram illustrating example operations related to federated learning and training of the global machine-learning model facilitated by the metadata blockchain according to the present disclosure;

FIG. 3 is a diagram representing an example training round for a client included in the federated learning process and the training of the machine-learning model according to the present disclosure;

FIG. 4 is a flowchart of an example method of training a machine-learning model via federated learning according to the present disclosure;

FIG. 5 is a flowchart of an example method of securely aggregating local model updates included in federated learning and training of a machine-learning model according to the present disclosure; and

FIG. 6 is an example computing system.

### DETAILED DESCRIPTION

Federated learning is a distributed machine-learning approach in which a machine-learning model implemented on a central server (“global machine-learning model”) is trained based on one or more decentralized datasets. The decentralized datasets (“local datasets”) may include private and/or sensitive data, such as patient health data and telecommunication data, and each decentralized dataset may be owned and/or managed by different, individual systems that are referred to as “clients” in the present disclosure. Transmitting the global machine-learning model rather than the local datasets may preserve bandwidth and/or data privacy because the training data included in the local datasets are not transmitted.

The embodiments of the present disclosure may relate to implementing a blockchain of published metadata associated with a global machine-learning model and local datasets each corresponding to a respective client to facilitate federated learning for the global machine-learning model. Implementation of the blockchain to facilitate federated learning may provide consensus on client selection for one or more training rounds of the global machine-learning model. Additionally or alternatively, publishing the metadata associated with the global machine-learning model and the local datasets and performing federated learning based on the published metadata may allow for more efficient and/or accurate exchange of machine-learning models between the clients and the central server. As such, the present disclosure may be directed to improving the efficiency and/or functionality of computing systems performing federated learning of the global machine-learning model.

Embodiments of the present disclosure are explained with reference to the accompanying figures.

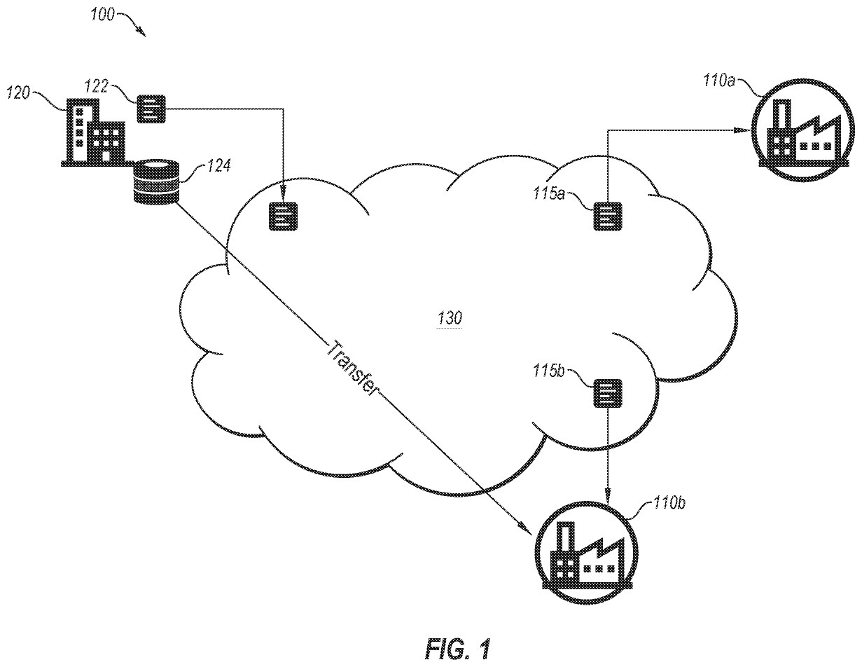

FIG. 1 is a diagram representing an example system 100 for federated learning and training of a global machine-learning model facilitated by a blockchain according to the present disclosure. The system 100 may include one or more clients 110a and 110b (collectively “clients 110”), a central server 120, and a blockchain 130. Each of the clients 110 may read from and/or publish to the blockchain 130 metadata 115a and 115b (collectively “metadata 115”). A client-selection policy 122 and/or machine-learning model data 124 may be stored on the central server 120.

The clients 110 may include code and routines configured to enable a computing system to perform one or more operations. Additionally or alternatively, the clients 110 may be implemented using hardware including a processor, a microprocessor (e.g., to perform or control performance of one or more operations), a field-programmable gate array (FPGA), or an application-specific integrated circuit (ASIC). The clients 110 may be configured to perform a series of operations with respect to the central server 120 and/or the blockchain 130.

In some embodiments, each of the clients 110 may include a local dataset that includes sensitive and/or private data such that transmission of data included in the local dataset may present a security risk for the client 110. For example, the local datasets may relate to patient health records, telecommunications information, proprietary research data, defense projects, etc. Additionally or alternatively, the local datasets of the clients 110 may include large amounts of data such that transmission of the local datasets of the clients 110 may be impractical and/or difficult.

In some embodiments, the local datasets may relate to the global machine-learning model of the central server 120. The data included in the local datasets may relate to the global machine-learning model in that the global machine-learning model is configured to analyze the local dataset and draw conclusions regarding the local dataset according to one or more training tasks in which the training tasks may relate to various data analyses the global machine-learning model is configured to perform. For example, a particular global machine-learning model may be configured to perform tasks that may analyze a wide variety of data depending on the type of data provided thereto. For example, with respect to telecommunications information, the tasks of the particular global machine may be such that a corresponding data analysis of the telecommunications information may include detection of non-responsive cell sites, prediction of hardware faults, and/or assessment of network performance. Therefore, a particular local dataset that includes telecommunications information may be used as part of the training tasks to train the particular global machine-learning model regarding the aforementioned data analyses in a federated learning environment.

The clients 110 may be configured to read and/or publish metadata available on the blockchain 130. In some embodiments, the clients 110 may publish metadata to the blockchain 130 in which the published metadata describes the local datasets of the clients 110 and/or the clients 110 themselves. For example, the metadata published to the blockchain 130 by the clients 110 may include one or more data field names associated with the local datasets of the clients, a number of data entries included in each of the local datasets, one or more computational resource specifications of the clients 110 (e.g., a number of processor cores and/or an amount of random-access memory of each of the clients 110), etc.

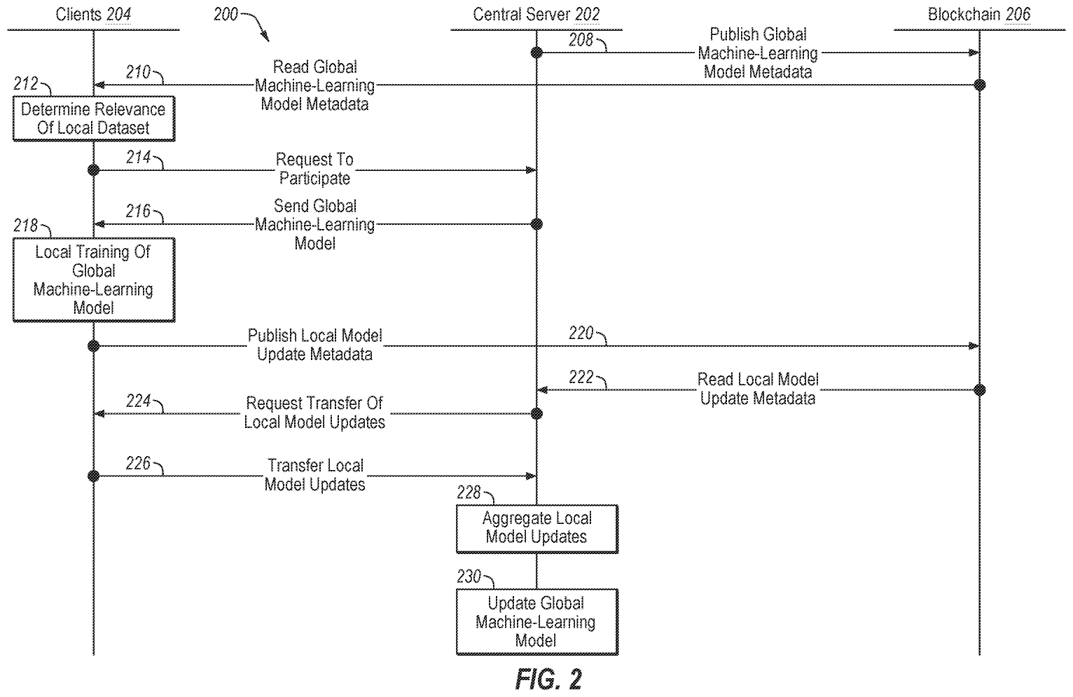

In some embodiments, the clients 110 may obtain the machine-learning model data 124 from the central server 120 and/or send to the central server 120 local model updates obtained by training the global machine-learning model based on the local datasets of the clients 110. Operations relating to training the local datasets of the clients 110 based on the global machine-learning model of the central server 120 are described in further detail below in relation to FIG. 2.

In some embodiments, the local model updates generated by the clients 110 may be masked. Masking the local model updates may prevent the central server 120 from identifying a particular local model update sent to the central server 120 by a particular client 110. As such, masking the local model updates may provide stronger client privacy and data security.

In some embodiments, masking a local model update generated by a first client (e.g., the client 110a) may include combining the local model update with one or more secret agreements between the first client, u, and a second client, v, that is also participating in the training round (e.g., the client 110b). Each of the secret agreements, s(u,v), may include a number (e.g., an integer), a string, etc. generated based on a communication between the first client and the second client such that a shared secret only known by the first client and the second client is generated. The first client may generate a first private key and a first public key, while the second client may generate a second private key and a second public key such that each client has a pair of keys including a private key and a public key. The first client may encrypt the secret agreement between the first client and the second client using the public key corresponding to the second client by any known cryptographic hash functions (e.g., SHA-2, SHA-3, MD5, etc.) such that an encrypted secret agreement may be generated according to the following function: encrypt(v_{public}, s(u, v)).

The encrypted secret agreement may be published to the blockchain 130, and the second client may read the blockchain 130 to obtain each secret agreement encrypted using the public key of the second client. Each of the obtained secret agreements may be decrypted using the private key of the second client according to the following function: decrypt(vₚᵣᵢᵥₐₜₑ, encrypt(v_{public}, s(u, v))), and the resulting decrypted secret agreements may be stored locally with the second client.

The number of secret agreements generated between clients 110, published to the blockchain 130, and used to mask the local model updates of the clients 110 may depend on the number of clients 110 selected to perform a training task because a secret agreement may be generated between each pair of clients 110. For example, a particular training task including three particular clients may include the following six secret agreements, s: s₁₂, s₁₃, s₂₁, s₂₃, s₃₁, and s₃₂. In this example, the secret agreements corresponding to a particular first client may include the secret agreements s₁₂ and s₁₃ such that the secret agreements s₁₂ and s₁₃ are encrypted using the public key of the particular first client and obtained from the blockchain 130 by the particular first client. Accordingly the secret agreements s₂₃ and s₂₁ are encrypted using a public key of a particular second client, and the secret agreements s₃₁ and s₃₂ are encrypted using a public key of a particular third client.

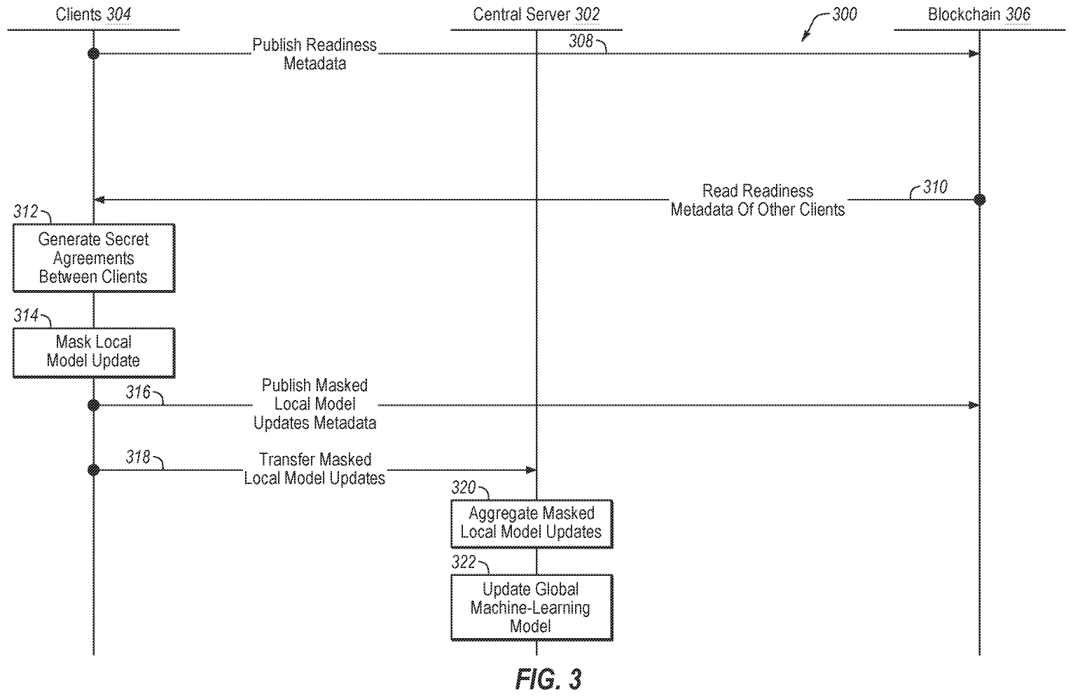

Each of the secret agreements corresponding to a given client may be combined with the local model update corresponding to the same given client to change a value of the local model update corresponding to the given client. In some embodiments, combining the secret agreements with the local model update for the given client may include adding, subtracting, concatenating, etc. the secret agreements and the local model update. Returning to the previous example, the particular first client may include a local model update, x₁, and masking the local model update may include determining a masked local model update, y₁, according to the following equation: y₁=x₁+s₁₂+s₁₃. Similarly, a masked local model update, y₂, corresponding to the particular second client including a local model update, x₂, may be determined as y₂=x₂+s₂₃−s₂₁, and a masked local model update, y₃, corresponding to the particular third client including a local model update, x₃, may be determined as y₃=x₃−s₃₁−s₃₂. Operations relating to transmission of the masked local model updates of the clients 110 and aggregation of the masked local model updates by the central server 120 are described in further detail below in relation to FIG. 3.

The central server 120 may include code and routines configured to enable a computing system to perform one or more operations. Additionally or alternatively, the central server 120 may be implemented using hardware including a processor, a microprocessor (e.g., to perform or control performance of one or more operations), a field-programmable gate array (FPGA), or an application-specific integrated circuit (ASIC). The central server 120 may be configured to perform a series of operations with respect to the clients 110 and/or the blockchain 130.

The central server 120 may include the machine-learning model data 124 that correspond to a global machine-learning model. The central server 120 may include an initial version of the global machine-learning model, and the central server 120 may publish metadata describing one or more training tasks associated with the initial version of the global machine-learning model to the blockchain 130. In some embodiments, training the initial version of the global machine-learning model may be facilitated by a federated-learning approach in which the central server 120 does not obtain training data for the global machine-learning model. In these and other embodiments, the global machine-learning model may send a local copy of the global machine-learning model (“local machine-learning model”) to each of the clients 110 and obtain local model updates from the clients 110, which may be determined by training the local machine-learning model based on the respective local dataset of each of the clients 110. The local model updates may include one or more parameters associated with the global machine-learning model, such as training weights of an artificial neural network, support vectors of a support vector machine, and/or coefficients of a linear regression system, and the central server 120 may update the global machine-learning model based on the obtained parameters.

A client-selection policy 122 that includes one or more criteria for determining the suitability of the clients 110 for training the global machine-learning model may be stored on the central server 120. The criteria for determining the suitability of a given client 110 for training the global machine-learning model may relate to one or more measurements of the relevance of the local dataset of the given client 110 to the training tasks associated with the global machine-learning model and/or one or more measurements of the capability of the given client 110 to perform the training tasks associated with the global machine-learning model. For example, the client-selection policy 122 may disclose one or more data fields needed to perform a particular training task as a metric of the relevance of the local datasets of the clients 110 to the particular training task and/or the global machine-learning model. As another example, the client-selection policy 122 may disclose one or more computational resource requirements that the clients 110 must satisfy to be considered for a particular training task.

In some embodiments, the global machine-learning model may be trained by multiple clients 110 during a given training round such that the central server 120 receives multiple local model updates during the given training round. The central server 120 may aggregate the local model updates to determine an aggregated local model update representative of the given training round, and the aggregated local model update may be used to train the global machine-learning model.

In these and other embodiments, aggregation of the local model updates may include calculating a weighted average of the local model updates such that local model updates corresponding to clients 110 having more significant local datasets are more heavily represented in the aggregated local model update. For example, each of the local model updates may be weighed according to the number of data entries included in each respective local dataset such that local datasets including more data entries are weighed more heavily in the aggregated local model update. As another example, each of the local model updates may be weighed according to the training accuracy associated with training the global machine-learning model based on each respective local dataset such that local model updates including higher training accuracy are weighed more heavily in the aggregated local model update.

The blockchain 130 may include a list of records (“blocks”) in which each record included in the list contains a cryptographic hash of at least one previous record. The cryptographic hashes may each include information from the previous block(s), a timestamp of a transaction that is based on information included on the blockchain 130, and/or data of the transaction itself. Because each block included in the blockchain 130 contains a cryptographic hash of at least one previous block, the existing blocks of the blockchain 130 are resistant to data tampering and/or forgery. In some embodiments, the blockchain 130 may be managed by a peer-to-peer network such that the blockchain 130 may be reviewed and authenticated by each peer included in the peer-to-peer network. As such, the blockchain 130 may serve as a distributed public ledger for the peers included in the peer-to-peer network, and information published on the blockchain 130 may include information which a consensus has been reached by the peers.

The blockchain 130 may include metadata that describes the global machine-learning model of the central server 120, the clients 110, and/or the local datasets of the clients 110. For example, the metadata published to the blockchain 130 may include one or more metadata fields, such as a training task identifier, a training round identifier, a client identifier, a number of training samples (e.g., data entries) included in a given local dataset, a training accuracy of a locally trained machine-learning model and/or a global machine-learning model, a testing accuracy of a locally trained machine-learning model and/or a global machine-learning model, a file name of the global machine-learning model, a threshold number of clients required for a given training round, a threshold training accuracy required for a given training round, etc. In some embodiments, the metadata may be published as individual blocks on the blockchain 130 such that each individual block of the blockchain 130 includes metadata relating to a respective client and/or local dataset for a given training round.

Additionally or alternatively, the metadata published in individual blocks on the blockchain 130 may relate to the global machine-learning model and/or the central server 120 for a given training round. In these and other embodiments, the metadata may be compiled in a list such that more than one metadata field is published to each of the individual blocks on the blockchain 130. For example, the metadata of a particular local dataset and its corresponding local model update may be configured as a list including the training task identifier, the training round identifier, the client identifier, the number of training samples included in the local dataset, and the training accuracy of the locally trained machine-learning model (e.g., metadata={taskID, roundID, clientID, numSamples, trainAcc}).

In some embodiments, the metadata published on the blockchain 130 may exclude the data of the global machine-learning model itself and/or the data included in the local datasets themselves. As such, the amount of data stored on the blockchain 130 may be less than an amount of data stored on a blockchain including the data of a machine-learning model and/or the local datasets, and the amount of data read from the blockchain 130 may be reduced relative to the blockchain including the data of the machine-learning model and/or the local datasets.

Modifications, additions, or omissions may be made to the system 100 without departing from the scope of the present disclosure. For example, the designations of different elements in the manner described is meant to help explain concepts described herein and is not limiting. For instance, in some embodiments, the central server 120, the clients 110, and/or the blockchain 130 are delineated in the specific manner described to help with explaining concepts described herein but such delineation is not meant to be limiting. Further, the system 100 may include any number of other elements or may be implemented within other systems or contexts than those described.

FIG. 2 is a diagram illustrating example operations 200 related to federated learning and training of the global machine-learning model facilitated by the metadata blockchain according to the present disclosure. The operations 200 may be arranged in accordance with at least one embodiment described in the present disclosure. In the illustrated example, the operations 200 may be between a central server 202, one or more clients 204, and a blockchain 206. In some embodiments, the central server 202, the clients 204, and the blockchain 206 may be analogous to the central server 120, the clients 110, and the blockchain 130, respectively, of FIG. 1. Accordingly, no further explanation is provided with respect thereto. Additionally or alternatively, the operations 200 may be an example of the operation of the elements of the environment of FIG. 1.

In some embodiments, the operations 200 may be an example of communications and interactions between the central server 202, the clients 204, and the blockchain 206. Generally, the operations 200 may relate to management of communications between the central server 202 and the clients 204 to facilitate federated learning of a global machine-learning model. The operations 200 illustrated are not exhaustive but are merely representative of operations 200 that may occur. Furthermore, one operation as illustrated may represent one or more communications, operations, and/or data exchanges.

At operations 208, metadata associated with the global machine-learning model of the central server 202 may be published to the blockchain 206. The metadata associated with the global machine-learning model at the operations 208 may include metadata associated with an initial version of the global machine-learning model (“initial metadata”) in which the global-machine learning model has not received any local model updates from the clients 204. As such, the initial version of the global machine-learning model may not be trained, and the metadata associated with the global machine-learning model may indicate that the global machine-learning model is on a first training round (e.g., roundID=0). Additionally or alternatively, the initial metadata may include a training task identifier (e.g., taskID).

In these and other embodiments, the initial metadata may include information included in a client-selection policy. The information included in the client-selection policy may include one or more data fields needed to perform a particular training task and/or one or more computational resource requirements for performing the particular training task as described above in relation to the client-selection policy 122 of the central server 120 in FIG. 1.

At operations 210, the clients 204 may read the initial metadata of the global machine-learning model from the blockchain 206. At operations 212, each of the clients 204 may determine whether the respective local dataset is relevant to a given training task based on the client-selection policy information included in the initial metadata. For example, the client 204 may determine whether its respective local dataset is relevant to one or more of the training tasks of the global machine-learning model based on whether the data fields included in the local dataset are the same and/or similar to the data fields included in the initial metadata. As another example, the client 204 may determine whether the client 204 is capable of performing the training task based on whether the client satisfies the computational resource requirements included in the initial metadata.

In response to one or more of the clients 204 determining that its respective local dataset is relevant to performing the training tasks, the clients 204 including relevant local datasets may request to participate in training the global-machine learning model at operations 214. The central server 202 may send data associated with the global machine-learning model to the clients 204 capable of performing the training tasks at operations 216 such that the respective local dataset corresponding to each of the clients 204 may be used to train the global machine-learning model at operations 214. In some embodiments, training the global machine-learning model may include determining one or more parameters of the global machine-learning model by using the data included in the local datasets as training data. For example, the global machine-learning model may include an artificial neural network, and training the artificial neural network using the local datasets may result in determining one or more training weights associated with the neural nodes of the artificial neural network based on the data included in the local datasets.

At operations 218, the metadata associated with the local model updates may be published to the blockchain 206. In some embodiments, the metadata associated with each of the clients 204 may be published as part of individual blocks of the blockchain 206, and at operations 220, the metadata of the local model updates may be obtained by the central server 202.

Based on the metadata of the local model updates, one or more local model updates may be transferred from the clients 204 to the central server 202. At operations 222, the central server 202 may read the blockchain 206 and identify which of the clients 204 published metadata relating to their respective local model updates to the blockchain 206. In some embodiments, the central server 202 may read the metadata of the local model updates corresponding to the clients 204 to determine whether a threshold number of local model updates are available. Responsive to determining that the threshold number of local model updates are available, the central server 202 may send requests to each of the clients 204 that published metadata indicating their local model updates are ready to transfer their local model updates to the central server 202 at operations 224. At operations 226, the clients 204 may transfer the local model updates to the central server 202 such that the central server 202 may select and obtain at least the threshold number of local model updates from the clients 204 to update the global machine-learning model. For example, a given threshold number of local model updates may be set by the central server 202 to be ten local model updates. In such an example, the central server 202 may determine that twelve local model updates are available. In other words, twelve clients 204 have trained local machine-learning models based on the local datasets corresponding to each of the twelve clients 204. The central server 202 may select the threshold number of local model updates (ten), more than the threshold number of local model updates (e.g., eleven), and/or all of the local model updates (twelve) to be transferred from the clients 204 to the central server 202 because the number of available local model updates has satisfied the threshold number of local model updates.

At operations 228, the central server 202 may aggregate the local model updates obtained from the clients 204. In some embodiments, the local model updates may be averaged to determine an aggregated local model update. Additionally or alternatively, a weighted average of the local model updates may be calculated. The weighing of each of the local model updates may be based on the number of data entries included in each respective local dataset corresponding to each of the local model updates. Additionally or alternatively, the weighing of each of the local model updates may be based on a training accuracy and/or a testing accuracy of each of the local model updates. In these and other embodiments, the weighted average of the local model updates, x₀, may be calculated according to the following equation:

$${x}_{0} = \frac{{x}_{1} {p}_{1} + {x}_{2} {p}_{2} + … + {x}_{n} {p}_{n}}{{p}_{1} + {p}_{2} + … + {p}_{n}} \qquad ( 1 )$$

in which x₁, x₂, and xₙ represent a first, a second, and an Nth local model update, respectively, and p₁, p₂, and pₙ represent weights corresponding to the first, the second, and the Nth local model update, respectively.

At operations 230, the global machine-learning model of the central server 202 may be updated based on the aggregated local model update determined at the operations 228. In some embodiments, values of the parameters of the global machine-learning model may be replaced by the values of the parameters included in the aggregated local model update. In these and other embodiments, determining the updated global machine-learning model may indicate an end of a given training round. As such, the training round identifier may be incremented after determining the updated global machine-learning model. Additionally or alternatively, metadata associated with the updated global machine-learning model may be published to the blockchain 206 such that another training round may be initiated according to the same or a similar process as described in the operations 200. In these and other embodiments, the central server 202 may include a threshold number of training rounds (e.g., a minimum number of training rounds), and the operations 200 may be repeated until the threshold number of training rounds is satisfied.

Modifications, additions, or omissions may be made to the operations 200 without departing from the scope of the present disclosure. In these or other embodiments, one or more operations associated with the operations 200 may be omitted or performed by a device other than the central server 202, the clients 204, and/or the blockchain 206. Further, the operations 208, 210, 212, 214, 216, 218, 220, 222, 224, 226, 228 and/or 230 may be performed in an ongoing basis such that more than one training rounds for the global machine-learning model of the central server 202 are performed. In addition, one or more operations may be performed by different devices than as described.

FIG. 3 is a diagram illustrating example operations 300 related to secure aggregation of local model updates according to the present disclosure. The operations 300 may be arranged in accordance with at least one embodiment described in the present disclosure. In the illustrated example, the operations 300 may be between a central server 302, one or more clients 304, and a blockchain 306. In some embodiments, the central server 302, the clients 304, and the blockchain 306 may be analogous to the central server 120, the clients 110, and the blockchain 130, respectively, of FIG. 1, and/or to the central server 202, the clients 204, and the blockchain 206, respectively, of FIG. 2. Accordingly, no further explanation is provided with respect thereto. Additionally or alternatively, the operations 300 may be an example of the operation of the elements of the environment of FIG. 1.

In some embodiments, the operations 300 may be an example of communications and interactions between the central server 302, the clients 304, and the blockchain 306. Generally, the operations 300 may relate to management of communications between the central server 302 and the clients 304 to facilitate federated learning of a global machine-learning model. The operations 300 illustrated are not exhaustive but are merely representative of operations 300 that may occur. Furthermore, one operation as illustrated may represent one or more communications, operations, and/or data exchanges.

At operations 308, metadata associated with one or more local model updates and/or respective clients 304 to which the local model updates correspond may be published to the blockchain 306 to indicate a readiness of each of the respective clients 304 to submit their respective local model updates to the central server 302. In some embodiments, the metadata associated with a particular local model update and/or a particular client may include an indication of a readiness of a respective client 304 to submit the particular local model update to the central server 302. For example, the metadata may include a metadata field (e.g., readyID) indicating the readiness of the respective client 304 to submit the particular local model update to the central server 302. In this example, the metadata field may include a first value indicating the respective client 304 is not ready (e.g., readyID=0), which may mean that the respective client 304 has not generated a respective local model update. The metadata field may include a second value indicating the respective client 304 is ready (e.g., readyID=1), which may mean the respective client 304 has generated a respective local model update.

At operations 310, the clients 304 may read the readiness metadata of the other clients 304 to determine which of the clients 304 will be participating in a given training round. Each client 304 participating in the given training round may identify the same clients 304 participating in the given training round because the determining of which clients 304 will be participating in the given training round is published to the blockchain 306. At operations 312, secret agreements may be generated by each of the clients participating in the given training round. In some embodiments, each of the participating clients may generate a secret agreement with each of the other clients participating in the same given training round such that the number of secret agreements generated by a particular client is one less than a total number of clients participating in the given training round. The secret agreements may be generated as described in FIG. 1.

At operations 314, the local model updates may be masked by using the generated secret agreements. In some embodiments, the secret agreements generated by a particular client may be combined with the respective local model update corresponding to the particular client. Combining the local model update and the secret agreements may include performing one or more mathematical operations in which the local model update and the secret agreements are used as arguments as described in relation to FIG. 1. Additionally or alternatively, combining the local model update and the secret agreements may include concatenating and/or appending the secret agreements to the local model update.

At operations 316, metadata of the masked local model updates may be published to the blockchain 306. Publishing the metadata of the masked local model updates and/or the clients 304 associated with the masked local model updates may facilitate aggregation of the masked local model updates by the central server 302 as described below in relation to operations 320. In some embodiments, the metadata of the masked local model updates may include a metadata field indicating which of the clients are participating in the given training round. This metadata may include the same as or similar to the readiness metadata published by each of the clients 304 at the operations 308 in that the metadata of the masked local model may include an indication of which of the clients 304 are ready to participate in the given training round. For example, the metadata of the masked local model updates may include a metadata field including a list of client identifiers corresponding to the participating clients (e.g., secureAggregation={clientID_1, clientID_2, . . . , clientID_n}). Additionally or alternatively, the metadata of the masked local model updates may include a metadata field indicating whether the local model update is masked (e.g., a maskID metadata field). Additionally or alternatively, the metadata of the masked local model updates may include one or more metadata fields as described in relation to FIG. 1.

At operations 318, the masked local model updates may be transferred to the central server 302, and at operations 320, the masked local model updates may be aggregated by the central server 302 as an aggregated local model update. Because each of the qualified clients may generate a secret agreement with each of the other qualified clients, a secret agreement generated between a first client and a second client may include the same value as a secret agreement generated between the second client and the first client. As such in some embodiments, aggregating the masked local model updates may include identifying one or more pairs of secret agreements of the masked local model updates in which each of the pairs of secret agreements include two secret agreements between the same qualified clients. The identified pairs of secret agreements may be removed from the aggregated masked local model update such that only the local model updates remain in the aggregated masked local model update.

Additionally or alternatively, each of the masked local model updates, y₁, may be aggregated according to the following mathematical relation:

Σ_{i∈n}yᵢ=Σ_{i∈n}(xᵢ+Σ_{i∈n}s_{u,v}−Σ_{i∈n}s_{v,u})=Σ_{i∈n}xᵢ (2)

in which xᵢ represents the local model updates, s_{u,v} and s_{v,u} represents the secret agreements. As indicated in the mathematical relation above, pairs of secret agreements between two of the same qualified clients may be removed from the aggregated local model update such that only the local model updates corresponding to the qualified clients remain after aggregating the masked local model updates. The global machine-learning model may be updated based on the aggregated masked local model updates at operations 322, which may be the same or similar to updating the global machine-learning model at the operations 230 of FIG. 2.

Modifications, additions, or omissions may be made to the operations 300 without departing from the scope of the present disclosure. In these or other embodiments, one or more operations associated with the operations 300 may be omitted or performed by a device other than the central server 302, the clients 304, and/or the blockchain 306. As another example, in some embodiments, the operations 300 may be arranged in a different order or performed at the same time. Further, the operations 308, 310, 312, 314, 316, 318, 320, and/or 322 may be performed in an ongoing basis such that more than one training rounds for the global machine-learning model of the central server 302 are performed. In addition, one or more operations may be performed by different devices than as described.

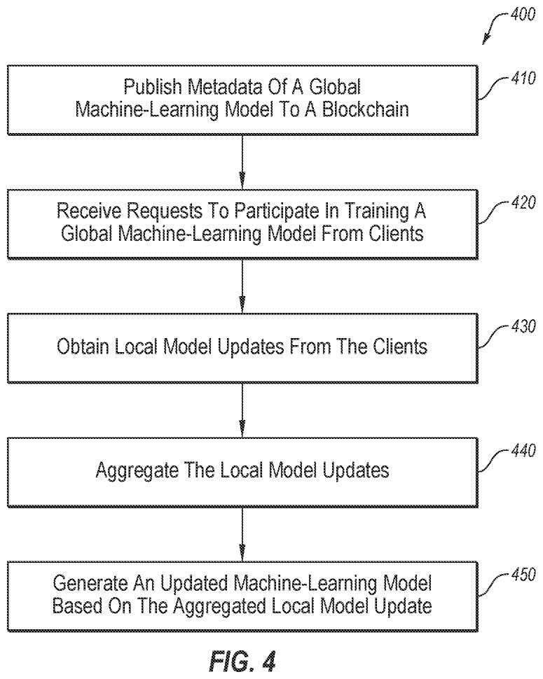

FIG. 4 is a flowchart of an example method 400 of training a machine-learning model via federated learning according to the present disclosure. The method 400 may be performed by any suitable system, apparatus, or device. For example, the central server 120, the clients 110, and/or the blockchain 130 may perform one or more operations associated with the method 400. Although illustrated with discrete blocks, the steps and operations associated with one or more of the blocks of the method 400 may be divided into additional blocks, combined into fewer blocks, or eliminated, depending on the particular implementation.

The method 400 may begin at block 410, where metadata corresponding to a global machine-learning model may be published to a blockchain. The metadata corresponding to the global machine-learning model may include information describing an initial version of the global machine-learning model in which the initial version of the global machine-learning model has not been trained as described in relation to FIG. 1.

At block 420, requests to participate in training the global machine-learning model may be received from one or more clients. In some embodiments, the requests to participate in the training of the global machine-learning model may be made by the clients based on whether the clients qualify to participate in the training according to a client-selection policy, such as the client-selection policy 122 as described in relation to FIG. 1. In some embodiments, the requests to participate in the training of the global machine-learning model may be published to the blockchain such that a central server and/or other clients may review the requests and identify which clients may participate in the training of the global machine-learning model. A group of clients may be selected as qualified clients to participate in the training of the global machine-learning model based on the requests to participate.

At block 430, one or more local model updates may be obtained from the clients participating in the training of the global machine-learning model. Each of the clients may include a respective local dataset, and the global machine-learning model may be trained using the data included in the respective local dataset to determine a respective local model update. The local model update may include one or more parameters associated with the performance of the global machine-learning model, such as training weights for an artificial neural network, support vectors of a support vector machine, and/or coefficients of a linear regression system.

At block 440, the local model updates obtained by the central server may be aggregated as an aggregated local model update as described in relation to FIG. 2. At block 450, the global machine-learning model may be updated based on the aggregated local model update as described in relation to FIG. 2.

Modifications, additions, or omissions may be made to the method 400 without departing from the scope of the disclosure. For example, the designations of different elements in the manner described is meant to help explain concepts described herein and is not limiting. Further, the method 400 may include any number of other elements or may be implemented within other systems or contexts than those described.

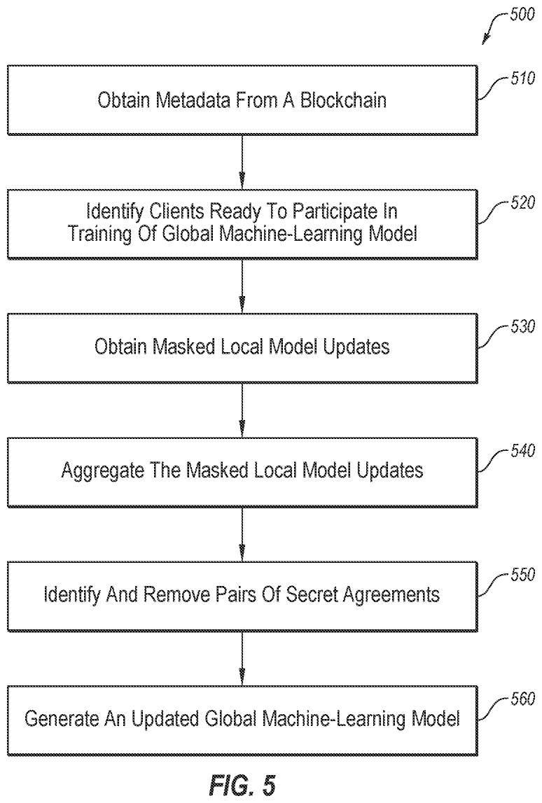

FIG. 5 is a flowchart of an example method 500 of securely aggregating local model updates included in federated learning and training of a machine-learning model according to the present disclosure. The method 500 may be performed by any suitable system, apparatus, or device. For example, the central server 120, the clients 110, and/or the blockchain 130 may perform one or more operations associated with the method 500. Although illustrated with discrete blocks, the steps and operations associated with one or more of the blocks of the method 500 may be divided into additional blocks, combined into fewer blocks, or eliminated, depending on the particular implementation.

The method 500 may begin at block 510, where metadata corresponding to one or more clients published to a blockchain may be obtained. In some embodiments, the metadata corresponding to a respective client may include an indication of a readiness of the respective client to submit (e.g., to a central server) a respective local model update in which the respective local model update was generated by training a global machine-learning model using a respective local dataset of the respective client.

At block 520, qualified clients may be identified based on a client-selection policy included in the obtained metadata. The readiness of the clients to submit the respective local model updates of each of the clients may be determined by the client-selection policy, and in some embodiments, the metadata may include information about the client-selection policy. Additionally or alternatively, the metadata may include information related to information included in the client-selection policy such that whether a particular client is qualified may be determined by comparing the information included in the metadata and the information included in the client-selection policy. For example, a particular client-selection policy may include one or more data fields relevant to a particular training task and/or one or more computational resource requirements as described in relation to FIG. 1. Particular metadata may include one or more data fields included in a particular local dataset and/or one or more computational resource specifications of a particular client. In this example, the data fields relevant to the training task and the data fields included in the particular local dataset may be compared to determine if the particular local dataset is relevant to the particular training task, and the computational resource requirements may be compared to the computational resource specifications of the particular client to determine if the particular client is capable of performing the particular training task.

At block 530, masked local model updates corresponding to the qualified clients may be obtained by the central server. Masking the local model updates may include combining the local model updates with one or more secreta agreements generated between the qualified clients as described in FIGS. 1 and 3.

At block 540, the masked local model updates may be aggregated as an aggregated masked local model update as described in FIG. 3. At block 550, one or more pairs of secret agreements may be identified and removed from the aggregated local model update. Additionally or alternatively, the aggregation of the masked local model updates may be performed according to Equation 2 as described in relation to FIG. 3 such that the secret agreements are removed from the aggregated masked local model update without identification and removal of the pairs of secret agreements. At block 560, an updated global machine-learning model may be generated based on the aggregated local model update as described in relation to FIG. 3.

Modifications, additions, or omissions may be made to the method 500 without departing from the scope of the disclosure. For example, the designations of different elements in the manner described is meant to help explain concepts described herein and is not limiting. Further, the method 500 may include any number of other elements or may be implemented within other systems or contexts than those described.

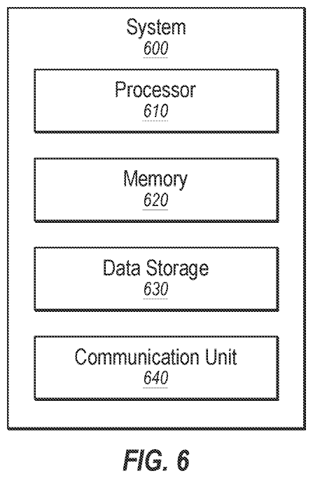

FIG. 6 illustrates an example computing system 600, according to at least one embodiment described in the present disclosure. The computing system 600 may include a processor 610, a memory 620, a data storage 630, and/or a communication unit 640, which all may be communicatively coupled. Any or all of the system 100 of FIG. 1 may be implemented as a computing system consistent with the computing system 600, including the clients 110, the central server 120, and/or the blockchain 130.

Generally, the processor 610 may include any suitable special-purpose or general-purpose computer, computing entity, or processing device including various computer hardware or software modules and may be configured to execute instructions stored on any applicable computer-readable storage media. For example, the processor 610 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 6, it is understood that the processor 610 may include any number of processors distributed across any number of network or physical locations that are configured to perform individually or collectively any number of operations described in the present disclosure. In some embodiments, the processor 610 may interpret and/or execute program instructions and/or process data stored in the memory 620, the data storage 630, or the memory 620 and the data storage 630. In some embodiments, the processor 610 may fetch program instructions from the data storage 630 and load the program instructions into the memory 620.

After the program instructions are loaded into the memory 620, the processor 610 may execute the program instructions, such as instructions to perform any of the methods 400 and/or 500 of FIGS. 4 and 5, respectively. For example, the processor 610 may publish metadata of a global machine-learning model to a blockchain, receive requests to participate in training the global machine-learning model from one or more clients, obtain local model updates from the clients, aggregate the local model updates, and/or generate an updated global machine-learning model based on the aggregated local model update.

The memory 620 and the data storage 630 may include computer-readable storage media or one or more computer-readable storage mediums for having computer-executable instructions or data structures stored thereon. Such computer-readable storage media may be any available media that may be accessed by a general-purpose or special-purpose computer, such as the processor 610. For example, the memory 620 and/or the data storage 630 may store local model updates, aggregated local model updates, the client-selection policy 122, and/or the machine-learning model data 124. In some embodiments, the computing system 600 may or may not include either of the memory 620 and the data storage 630.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 610 to perform a certain operation or group of operations.

The communication unit 640 may include any component, device, system, or combination thereof that is configured to transmit or receive information over a network. In some embodiments, the communication unit 640 may communicate with other devices at other locations, the same location, or even other components within the same system. For example, the communication unit 640 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 640 may permit data to be exchanged with a network and/or any other devices or systems described in the present disclosure. For example, the communication unit 640 may allow the system 600 to communicate with other systems, such as computing devices and/or other networks.

One skilled in the art, after reviewing this disclosure, may recognize that modifications, additions, or omissions may be made to the system 600 without departing from the scope of the present disclosure. For example, the system 600 may include more or fewer components than those explicitly illustrated and described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and processes described herein are generally described as being implemented in software (stored on and/or executed by general purpose hardware), specific hardware implementations or a combination of software and specific hardware implementations are also possible and contemplated.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method comprising:
obtaining metadata from a blockchain, the metadata including:
a readiness of a respective client of a plurality of clients to submit, to a central server, a respective local model update generated by training a global machine-learning model using a local dataset of the respective client; and
a client-selection policy indicating one or more criteria for a client to qualify to submit a respective masked local model update to the central server;
identifying a plurality of clients of the plurality of clients ready to participate in training the global machine-learning model based on the client-selection policy included in the metadata obtained from the blockchain;
obtaining the masked local model update from each of the identified clients in which each respective masked local model update corresponds to a respective identified client of the plurality of identified clients and in which the respective masked local model update includes:
a respective local model update for the global machine-learning model, the respective local model update being generated based on training, by the respective identified client, of the global machine learning model with a local dataset associated with the respective identified client; and
a plurality of secret agreements combined with the respective local model update in which each respective secret agreement of the plurality of secret agreements is between the respective identified client and another identified client of the plurality of identified clients, the combining of the plurality of secret agreements and the respective local model update masking the respective local model update associated with the respective identified client that is included in the respective masked local model update;
aggregating the plurality of masked local model updates to obtain an aggregated masked local model update;
identifying one or more pairs of secret agreements included in the aggregated masked local model update, each of the pairs of secret agreements including two secret agreements between the same identified clients;
removing the pairs of secret agreements from the aggregated masked local model update; and
generating an updated global machine-learning model based on the local model updates remaining in the aggregated masked local model update.

2. The method of claim 1, wherein obtaining a masked local model that corresponds to a respective identified client of the plurality of identified clients comprises:
determining a private key and a public key associated with the respective identified client;
determining a local model update corresponding to the respective identified client by using the local dataset associated with the respective identified client to train the global machine learning model;
obtaining a secret agreement between the respective identified client and a second identified client from the blockchain in which the secret agreement is encrypted using the public key associated with the respective identified client;
decrypting the encrypted secret agreement based on the private key of the respective identified client; and
pairing the decrypted secret agreement and the local model update to generate the masked local model.

3. The method of claim 2, wherein determining the local model update corresponding to the respective identified client further comprises determining a weighted local model update based on a number of data samples included in the local dataset corresponding to the respective identified client.

4. The method of claim 2, wherein the secret agreement between the pair of identified clients including the respective identified client and the second identified client includes at least one of a string including a plurality of characters and a randomly generated number.

5. The method of claim 1, wherein the client-selection policy is published to the blockchain and includes at least one of: a description of a training task, a computational resource requirement for the plurality of clients, or a training accuracy of the local model updates.

6. The method of claim 1, wherein the metadata related to the global machine-learning model and the plurality of clients include at least one of: a task identifier, a training-round identifier, a client identifier, a number of training samples, a training accuracy, a testing accuracy, a file name, or a threshold number of clients to be included in the training.

7. The method of claim 1, wherein each local model update of the plurality of local model updates comprises one or more parameters of the global machine-learning model including at least one of: a training weight, a support vector, or a coefficient.

8. One or more non-transitory computer-readable storage media configured to store instructions that, in response to being executed, cause a system to perform operations, the operations comprising:
obtaining metadata from a blockchain, the metadata including:
a readiness of a respective client of a plurality of clients to submit, to a central server, a respective local model update generated by training a global machine-learning model using a local dataset of the respective client; and
a client-selection policy indicating one or more criteria for a client to qualify to submit a respective masked local model update to the central server;
identifying a plurality of clients of the plurality of clients ready to participate in training the global machine-learning model based on the client-selection policy included in the metadata obtained from the blockchain;
obtaining the masked local model update from each of the identified clients in which each respective masked local model update corresponds to a respective identified client of the plurality of identified clients and in which the respective masked local model update includes:
a respective local model update for the global machine-learning model, the respective local model update being generated based on training, by the respective identified client, of the global machine learning model with a local dataset associated with the respective identified client; and
a plurality of secret agreements combined with the respective local model update in which each respective secret agreement of the plurality of secret agreements is between the respective identified client and another identified client of the plurality of identified clients, the combining of the plurality of secret agreements and the respective local model update masking the respective local model update associated with the respective identified client that is included in the respective masked local model update;
aggregating the plurality of masked local model updates to obtain an aggregated masked local model update;
identifying one or more pairs of secret agreements included in the aggregated masked local model update, each of the pairs of secret agreements including two secret agreements between the same identified clients;
removing the pairs of secret agreements from the aggregated masked local model update; and
generating an updated global machine-learning model based on the local model updates remaining in the aggregated masked local model update.

9. The one or more non-transitory computer-readable storage media of claim 8, wherein obtaining a masked local model that corresponds to a respective identified client of the plurality of identified clients comprises:
determining a private key and a public key associated with the respective identified client;
determining a local model update corresponding to the respective identified client by using the local dataset associated with the respective identified client to train the global machine learning model;
obtaining a secret agreement between the respective identified client and a second identified client from the blockchain in which the secret agreement is encrypted using the public key associated with the respective identified client;
decrypting the encrypted secret agreement based on the private key of the respective identified client; and
pairing the decrypted secret agreement and the local model update to generate the masked local model.

10. The one or more non-transitory computer-readable storage media of claim 8, wherein determining the local model update corresponding to the respective identified client further comprises determining a weighted local model update based on a number of data samples included in the local dataset corresponding to the respective identified client.

11. The one or more non-transitory computer-readable storage media of claim 8, wherein the secret agreement between the pair of identified clients including the respective identified client and the second identified client includes at least one of a string including a plurality of characters and a randomly generated number.

12. The one or more non-transitory computer-readable storage media of claim 8, wherein the client-selection policy is published to the blockchain and includes at least one of: a description of a training task, a computational resource requirement for the plurality of clients, or a training accuracy of the local model updates.

13. The one or more non-transitory computer-readable storage media of claim 8, wherein the metadata related to the global machine-learning model and the plurality of clients include at least one of: a task identifier, a training-round identifier, a client identifier, a number of training samples, a training accuracy, a testing accuracy, a file name, or a threshold number of clients to be included in the training.

14. The one or more non-transitory computer-readable storage media of claim 8, wherein each local model update of the plurality of local model updates comprises one or more parameters of the global machine-learning model including at least one of: a training weight, a support vector, or a coefficient.

15. A system comprising:
one or more processors; and
one or more non-transitory computer-readable storage media configured to store instructions that, in response to being executed, cause the system to perform operations, the operations comprising:
obtaining metadata from a blockchain, the metadata including:
a readiness of a respective client of a plurality of clients to submit, to a central server, a respective local model update generated by training a global machine-learning model using a local dataset of the respective client; and
a client-selection policy indicating one or more criteria for a client to qualify to submit a respective masked local model update to the central server;
identifying a plurality of clients of the plurality of clients ready to participate in training the global machine-learning model based on the client-selection policy included in the metadata obtained from the blockchain;
obtaining the masked local model update from each of the identified clients in which each respective masked local model update corresponds to a respective identified client of the plurality of identified clients and in which the respective masked local model update includes:
a respective local model update for the global machine-learning model, the respective local model update being generated based on training, by the respective identified client, of the global machine learning model with a local dataset associated with the respective identified client; and
a plurality of secret agreements combined with the respective local model update in which each respective secret agreement of the plurality of secret agreements is between the respective identified client and another identified client of the plurality of identified clients, the combining of the plurality of secret agreements and the respective local model update masking the respective local model update associated with the respective identified client that is included in the respective masked local model update;
aggregating the plurality of masked local model updates to obtain an aggregated masked local model update;
identifying one or more pairs of secret agreements included in the aggregated masked local model update, each of the pairs of secret agreements including two secret agreements between the same identified clients;
removing the pairs of secret agreements from the aggregated masked local model update; and
generating an updated global machine-learning model based on the local model updates remaining in the aggregated masked local model update.

16. The system of claim 15, wherein obtaining a masked local model that corresponds to a respective identified client of the plurality of identified clients comprises:
determining a private key and a public key associated with the respective identified client;
determining a local model update corresponding to the respective identified client by using the local dataset associated with the respective identified client to train the global machine learning model;
obtaining a secret agreement between the respective identified client and a second identified client from the blockchain in which the secret agreement is encrypted using the public key associated with the respective identified client;
decrypting the encrypted secret agreement based on the private key of the respective identified client; and
pairing the decrypted secret agreement and the local model update to generate the masked local model.

17. The system of claim 15, wherein determining the local model update corresponding to the respective identified client further comprises determining a weighted local model update based on a number of data samples included in the local dataset corresponding to the respective identified client.

18. The system of claim 15, wherein the secret agreement between the pair of identified clients including the respective identified client and the second identified client includes at least one of a string including a plurality of characters and a randomly generated number.

19. The system of claim 15, wherein the client-selection policy is published to the blockchain and includes at least one of: a description of a training task, a computational resource requirement for the plurality of clients, or a training accuracy of the local model updates.

20. The system of claim 15, wherein the metadata related to the global machine-learning model and the plurality of clients include at least one of: a task identifier, a training-round identifier, a client identifier, a number of training samples, a training accuracy, a testing accuracy, a file name, or a threshold number of clients to be included in the training.
